(19) United States
(12) Patent Application Publication
(10) Pub. No.: US 2021/0372453 A1
(43) Pub. Date: Dec. 2, 2021

(54) CONNECTION SYSTEM

(71) Applicant: BROME BIRD CARE INC., Knowlton (CA)

(72) Inventors: Paul L. COTE, Knowlton (CA); Denis MALAKET, Knowlton (CA)

(73) Assignee: BROME BIRD CARE INC., Knowlton (CA)

(21) Appl. No.: 17/208,745

(22) Filed: Mar. 22, 2021

Related U.S. Application Data
(60) Provisional application No. 63/031,983, filed on May 29, 2020.

(51) Int. Cl. F16B 21/12

(52) U.S. Cl. CPC F16B 21/12; F16B 2021/14

(57) ABSTRACT

The present disclosure provides connection systems that are preferably used with bird feeder poles. The connection system is further comprised of a pole that is secured to a surface, and a member that is secured around the pole. The member can be adapted to receive a number of bird feeding accessories, or the member itself can be a bird feeding accessory. The pole is comprised of at least one aperture adapted to receive a retention component. The retention component is configured to removably secure to the member to the pole.

### CROSS REFERENCE TO RELATED APPLICATION

The present application claims priority to U.S. Provisional Application No. 63/031,983, entitled “Hub Connection System” filed on May 29, 2020, the contents of which are incorporated herein by reference in their entirety.

### FIELD

The disclosure relates to the field of bird feeding accessories, and more specifically to a connection system for mounting poles.

### BACKGROUND

Bird feeders have been around for quite some time for bird watchers and animal lovers. Often, bird feeders are perched upon poles screwed into the ground, the poles having arms to receive the bird feeders or other outdoor accessories. The arms extend outwardly from hubs that are secured to the poles, as is known in the art. In other embodiments, a seed tray or other member is connected directly onto the pole. Unfortunately, there exists problems with the attachment of these members onto the poles, as they are only secured one to the other with a simple pin or dowel, through the pole and underneath the member. Indeed, connection systems such as the one described in U.S. Pat. No. 10,119,652 (Cote) exist but can be problematic as the pin cannot be properly positioned and secured to the pole and to the hub, leading to the pin falling or moving out of position over time. When the pin is loose or disconnected, the entire hub can fall down, which in turn leads to damage to the bird feeder or other accessory falling down as well.

As such, there is a need for an improved pole connection system that can overcome the problems of the prior art.

### SUMMARY

In an aspect, the present disclosure provides a connection system comprising: a pole to be secured to a surface, the pole further comprised of at least one aperture; a member removably secured to the pole, the member further comprised of at least one cavity; a retention component inserted within the at least one cavity of the member and through the at least one aperture of the pole, the retention component to removably secure the member to the pole.

In another aspect, the present disclosure provides a connection system comprising: a pole to be secured to a surface, the pole further comprised of at least one aperture; a member removably secured to the pole, the member further comprised of openings; a retention component comprising: a pin inserted through the at least one aperture of the pole; and, a pair of arms hanging from the pin, the retention component to removably secure the member to the pole.

In yet another aspect, the present disclosure provides a connection system comprising: a pole to be secured to a surface, the pole further comprised of at least one aperture; a member removably secured to the pole; at least one retention component inserted through the at least one aperture of the pole, the retention component to removably retain the member on the pole.

### BRIEF DESCRIPTION OF THE DRAWINGS

The following figures serve to illustrate various embodiments of features of the disclosure. These figures are illustrative and are not intended to be limiting.

FIG. 1 is a perspective view of a pole secured to two hubs by means of a connection system, the hubs in turn connected to a plurality of accessories, according to an embodiment of the present disclosure;

FIG. 2 is a perspective view of the hub removably secured to the pole with the connection system of FIG. 1;

FIG. 3 is a cross-sectional perspective view of the hub removably secured to a pin and the pole of the hub connection system of FIG. 1;

FIG. 4 is an underside perspective view of the hub and the pin of the hub connection system of FIG. 1;

FIG. 5A is a cross-sectional front view of a connection system, according to another embodiment of the present disclosure;

FIG. 5B is a cross-sectional front view of a connection system, according to another embodiment of the present disclosure;

FIG. 5C is a cross-sectional perspective view of a connection system, according to another embodiment of the present disclosure;

FIG. 6A is a cross-sectional perspective view of a connection system, according to another embodiment of the present disclosure;

FIG. 6B is a front cross-sectional front view of a connection system, according to another embodiment of the present disclosure;

FIG. 6C is a perspective view of the connection system of FIG. 6B;

FIG. 7A is a perspective view of a hub releasably secured to a pin using a connection system, according to yet another embodiment of the present disclosure;

FIG. 7B is a cross-sectional perspective view of the hub and pin shown in FIG. 7A;

FIG. 8 is a cross-sectional front view of a hub removably secured to a pole by means of a connection system, according to another embodiment of the present disclosure;

FIG. 9 is a cross-sectional front view of a hub removably secured to a pole by means of a connection system, according to yet another embodiment of the present disclosure;

FIG. 10 is a cross-sectional front view of a hub removably secured to a pole by means of a connection system, according to yet another embodiment of the present disclosure;

FIG. 11A is a cross-sectional front view of a hub removably secured to a pole by means of a connection system, according to yet another embodiment of the present disclosure;

FIG. 11B is a perspective view of the connection system shown in FIG. 11A;

FIG. 12A is a front view of a hub removably secured to a pole by means of a connection system, according to yet another embodiment of the present disclosure;

FIG. 12B is a cross-sectional perspective view of the connection system shown in FIG. 12A;

FIG. 13 is a perspective view of a pole having a tray removably secured thereto by means of a connection system, according to another embodiment of the present disclosure;

FIG. 14 is an underside perspective view of the tray removably secured to the pole of FIG. 13; and,

FIG. 15 is an enlarged underside perspective view of the connection system shown in FIG. 14.

### DETAILED DESCRIPTION

The following embodiments are merely illustrative and are not intended to be limiting. It will be appreciated that various modifications and/or alterations to the embodiments described herein may be made without departing from the disclosure and any modifications and/or alterations are within the scope of the contemplated disclosure.

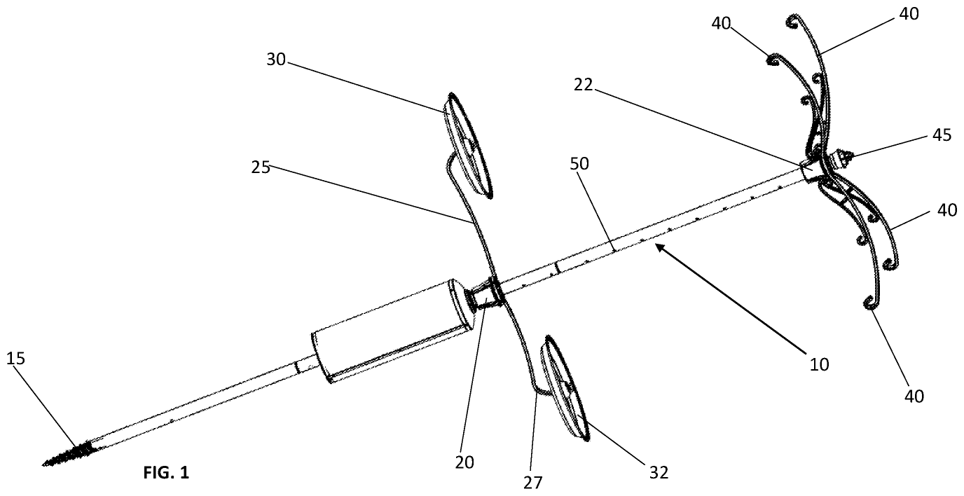

With reference to FIG. 1 and according to an embodiment of the present invention, a slotted pole 10 is shown having a plurality of accessories. The pole 10 has a threaded lower end 15 to be secured to the ground. Although typically the pole 10 is secured to the ground, it could also be secured to another surface such as a deck, plate, bracket, etc. A first and second hub 20, 22, are also shown, each of the hubs 20, 22 being removably secured to pole 10. Although hubs 20, 22 are shown, a worker skilled in the art would appreciate that any suitable member could be used, including but not limited to a tray, a bird feeder, a mailbox, etc, without departing from the scope of the disclosure. A pair of arm accessories 25, 27 are shown extending outwardly from the first hub 20, the arms 25, 27 terminating in trays 30, 32, respectively. Meanwhile, a plurality of hooks 40 are shown extending outwardly from the second hub 22. The second hub 22 is also capped by a finial 45. The pole 10 is further comprised of a plurality of apertures 50 in the form of slots along the length of the pole 10. A worker skilled in the art would appreciate that although slots are shown, other types of apertures 50 are possible along the length of the pole 10.

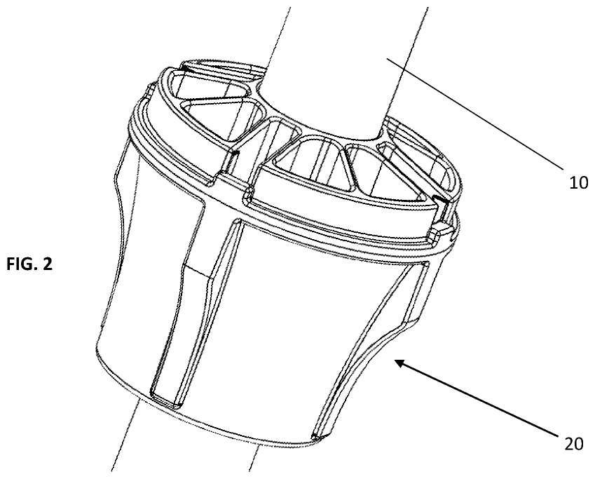

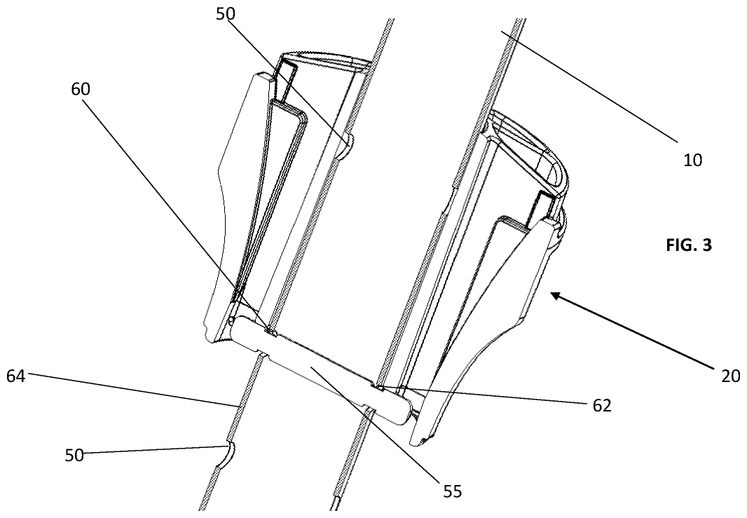

With reference to FIGS. 2 and 3 and according to an embodiment of the present disclosure, the first hub 20 is shown removably secured to the pole 10. The pole 10 is comprised of a plurality of slots 50 positioned along the length of the pole 10. A pin 55 is shown positioned through the slot 50 and underneath the hub 20, the pin 55 supporting the hub 20 and acting as a retention component. To remain in place within the slot 50, the pin 55 is further comprised of two annular grooves 60, 62. When the pin 55 is inserted within the slot 50, the annular grooves 60, 62 sit in opposite sides of the circumferential wall 64 of the pole 10. As such, the pin 55 cannot move laterally with respect to the pole 10 once the annular grooves 60, 62 sit on the circumferential wall 64. Indeed, it is a problem in the art that pins or other fastening members fall out of position when a hub is on a pole, which is necessarily avoided with the present hub connection system. As the pole 10 is comprised of a plurality of slots 50, an operator can choose the position of the hub 20 along the length of the pole 10. The annular grooves 60, 62 also serve to locate the pin 55 in a proper center position on the pole 10. A worker skilled in the art would appreciate that although a pin 55 is shown, any number of corresponding retention components could be used provided to retain the member in place.

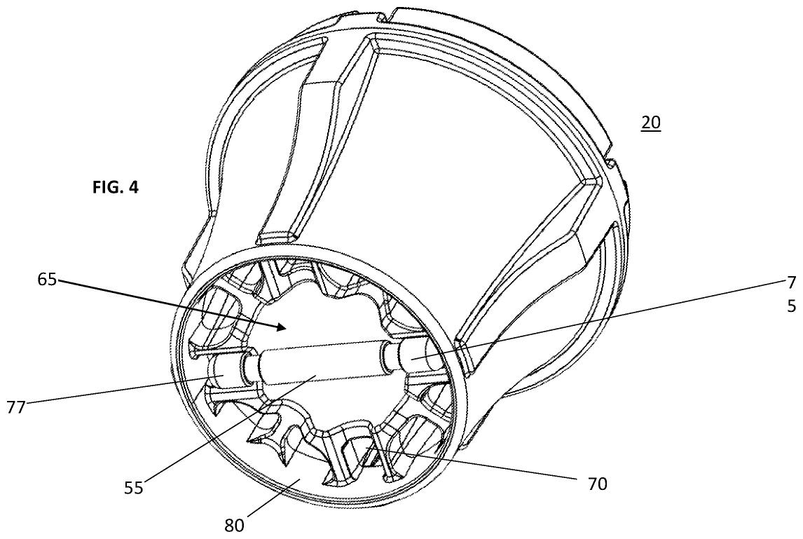

With reference to FIG. 4 and according to an embodiment of the present disclosure, an underside 65 of the hub 20 is shown. The underside 65 of the hub 20 is further comprised of at least one recessed portion 70, the shape of the recessed portion 70 generally corresponding to the cylindrical shape of the pin 55. A purpose of the recessed portion 70 is to confine and otherwise trap the outer ends 75, 77 of the pin 55 within the recessed portion 70 and inner circumferential wall 80 of the hub 20, so that the pin 55 does not move laterally independently of the hub 20. Once again a worker skilled in the art would appreciate that although a pin 55 is shown, a retention component could also be used.

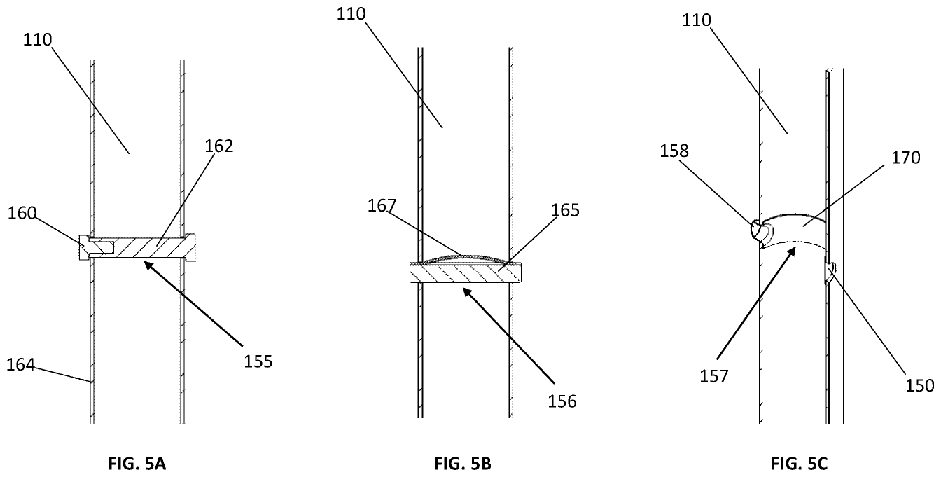

With reference to FIGS. 5A, 5B and 5C, poles 110 are shown in accordance with other embodiments of the present disclosure. Each of the poles 110 are further comprised of apertures 150 to receive a plurality of different retention components in this embodiment shown as pins 155, 156, 157. The hub (not shown) is then adapted to rest on such pins 155, 156, 157, such that the pins 155, 156, 157 act as retention components to retain the hub (not shown) thereon. With specific reference to FIG. 5A, the pin 155 is shown having an inner end 160 and an outer end 162. To secure the pin 155 within the aperture 150 of the pole 110, each of the inner and outer ends 160, 162 are inserted in opposite apertures and the inner end 160 is further inserted into the outer end 162. Each one of the inner and outer ends 160, 162 has a flange to secure against opposed walls 164 of the pole 110. With specific reference to FIG. 5B, the pin 156 is further comprised of a dowel 165 and a raised portion 167. The raised portion 167 is bendable. By inserting the dowel 165 into the aperture, the raised portion 167 bends accordingly until such point that the raised portion 167 will return to its original curved position inside of the pole 110, as shown in FIG. 5B. The raised portion 167 is then trapped inside of the pole 110 and the pin 156 cannot move laterally within the pole 110. With specific reference to FIG. 5C, the pin 157 is a C-clip 170 having a nipple 158. To position the pin 157 within the pole 110, the C-clip portion 170 of the pin 157 is compressed and inserted within the pole 110. The pin 157 is pushed all the way until the nipple 158 is fitted into the aperture 150. The nipple 158 then acts as a stopper to position the hub (not shown) thereon.

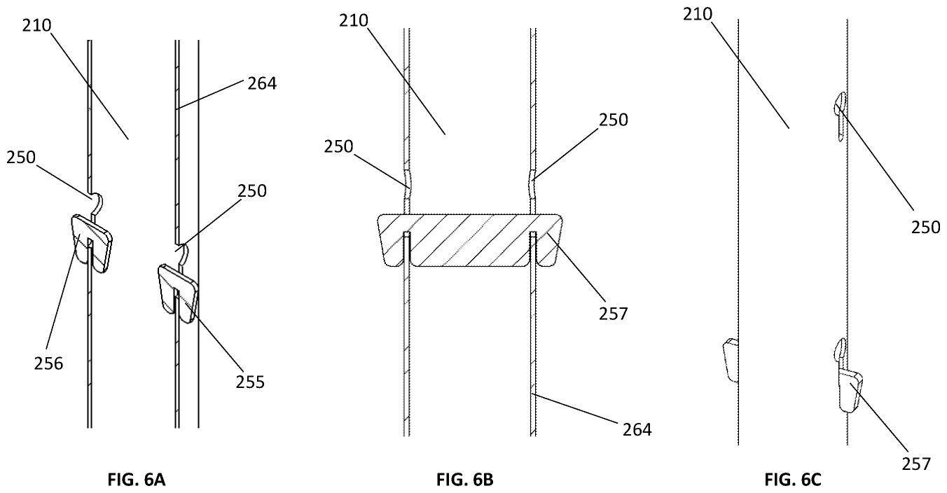

With reference to FIGS. 6A, 6B and 6C, poles 210 are shown in accordance with yet another embodiment of the present disclosure. Each of the poles 210 are further comprised of apertures 250 to receive a plurality of different retention components 255, 256, 257. With specific reference to FIG. 6A, two retention components 255, 256 are shown having a central slit. The first retention component 255 is positioned in the one aperture 250, while the second retention component 256 is positioned in the opposite aperture 250. The slits of the retention components 255, 256 are then aligned with the wall 264 of the pole 210 and the retention components 255, 256 are slid around the walls 264. A hub (not shown) can then be placed over the retention components 255, 256. With specific reference to FIGS. 6B and 6C, a single retention component 257 is shown, positioned in the aperture 250. The retention component 257 is comprised of two slits, each of the slits to be inserted into opposite sides of wall 264 of the pole 210. To secure the retention component 257 to the pole 210, the retention component 257 is inserted into one end of the aperture 250 and slid all the way to the other end of the opposed aperture 250. The slits of the retention component 257 are then aligned with opposing walls 264 of the pole 210 and inserted around such walls 264. A hub (not shown) can then be placed over the retention component 257.

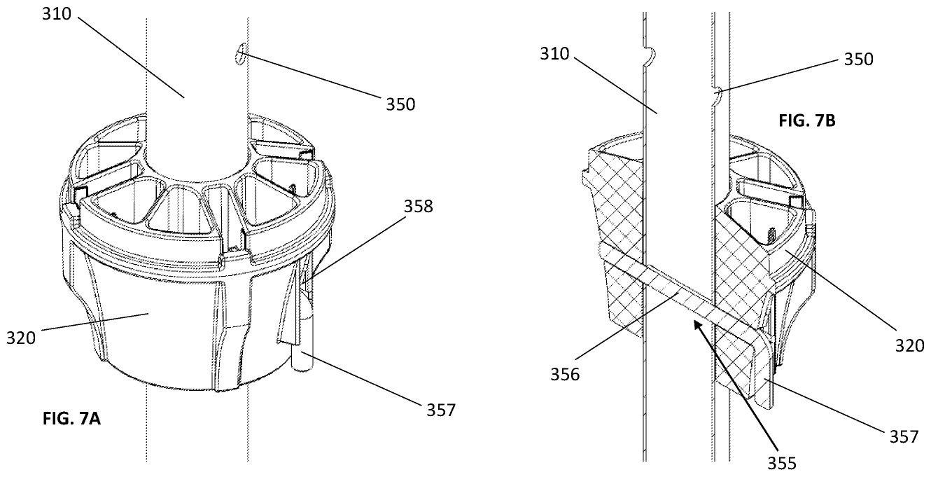

With reference to FIGS. 7A and 7B, a hub 320 is shown removably secured to the pole 310. A retention component shown as a pin 355 is inserted into the hub 320 and through the pole 310. As shown, the pin 355 is L-shaped, further comprised of a longitudinal portion 356 and a vertical portion 357. The hub 320 is further comprised of a cavity (not shown) adapted to receive the pin 355. To secure the hub 320 to the pole 310, the pin 355 is inserted through an aperture 350 of the pole 310 and into the cavity (not shown) of the hub 320. The vertical portion 357 is then aligned with a corresponding track 358 of the hub 320. In a preferred embodiment, the pin 355 stays in place by friction within the pole 310 but may also stay in place by being weighed down by the weight of the hub 320.

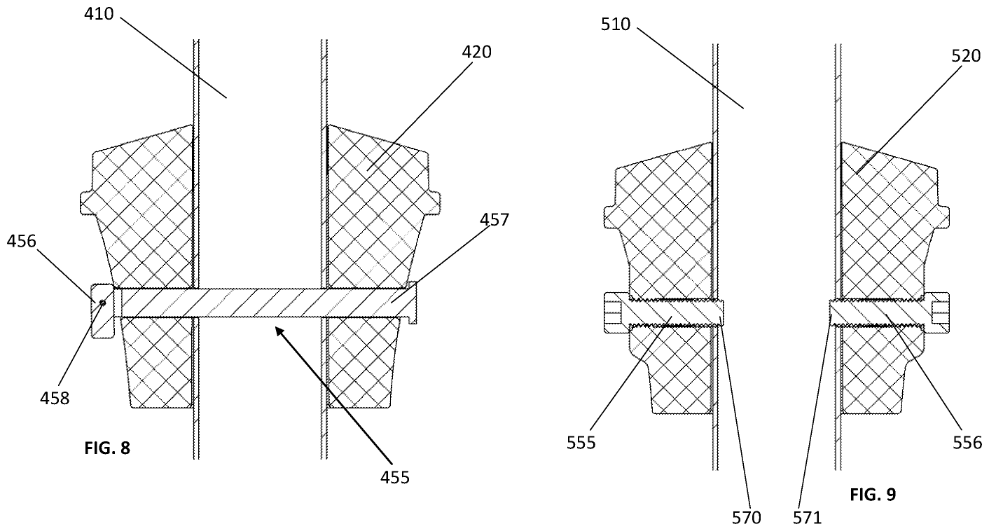

With reference to FIG. 8 and according to another embodiment of the present disclosure, a hub 420 is shown removably secured to a pole 410. A retention component shown as a pin 455 is shown, inserted within an aperture (not shown) of the hub 420. The pin 455 is further comprised of elongated member 457 and locking member 456. The locking member 456 pivots about pivot point 458. To insert the pin 455 through the hub 420 and the pole 410, the locking member 456 is pivoted to be in horizontal alignment with the elongated member 457. Once the pin 455 is completely through the hub 420, the locking member 456 is pivoted either up or down and can no longer be removed from the hub 420. The hub 420 is then locked onto the pole 410.

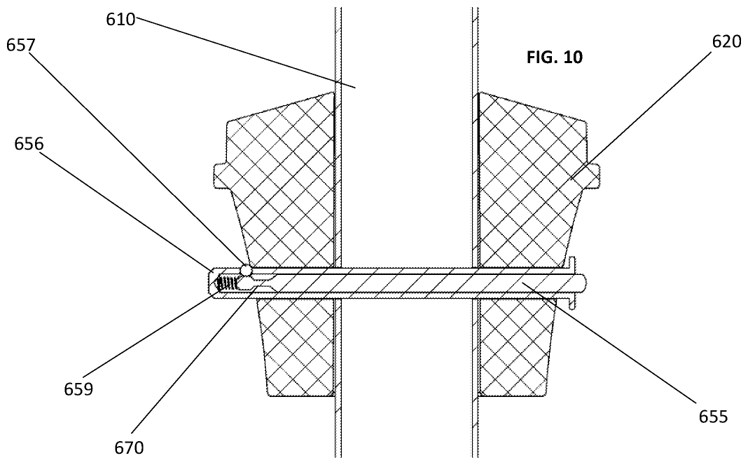

With reference to FIG. 9 and according to yet another embodiment of the present disclosure, a hub 520 is shown removably secured to a pole 510. A retention system is also shown, the retention system further comprised of retention components shown as first and second threaded rods 555, 556. To secure the hub 520 to the pole 510, the threaded rods 555, 556 are secured into the cavity (not shown) of the hub 520, the inner wall (not shown) of the cavity (not shown) being threaded. The threaded rods 555, 556 are threaded into the cavity (not shown) of the hub 520 until the lower ends 570, 571 of the rods 555, 556 are positioned within the pole 510. Once the threaded rods 556, 556 are inserted in this manner as specifically shown in FIG. 9, the hub 520 is removably secured to the pole 510. A worker skilled in the art would appreciate that the threaded rods 555, 556 could be a singular threaded rod threaded into the cavity (not shown) of the hub 520.

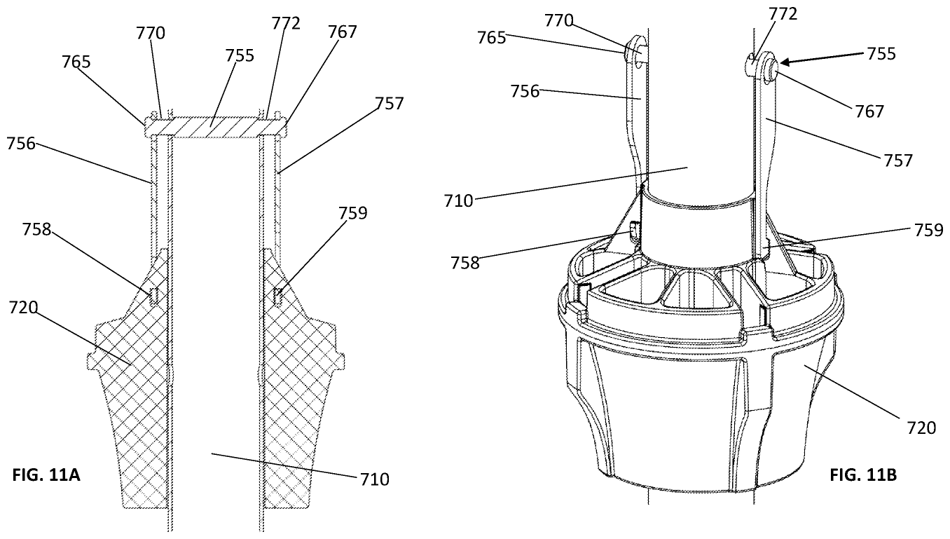

With reference to FIG. 10 and according to yet another embodiment of the present disclosure, a hub 620 is shown removably secured to a pole 610. An improved retention system is shown, the retention system comprised of an inner dowel 655 positioned in an outer dowel 656. The inner dowel 655 is further comprised of an annular recession 670 that is adapted to receive a ball bearing 657. The ball bearing 657 can move from a first position within the annular recession 670 and a second position in an opening (not shown) of the outer dowel 656 as specifically shown in FIG. 10. When the ball bearing 657 is in the second position in the opening (not shown) of the outer dowel 656, the ball bearing 657 protrudes from the outer dowel 656 and abuts onto the hub 620. In this position, the inner and outer dowels 655, 656 cannot be removed from the hub 620. In a preferred embodiment, a spring 659 is attached to the inner dowel 655 and the inner dowel 655 cannot be completely removed from the outer dowel 656. A worker skilled in the art would appreciate that there are a number of ways that a ball bearing 657 could be used to lock the inner and outer dowels 655, 656 through the hub 620 and into the pole 610.

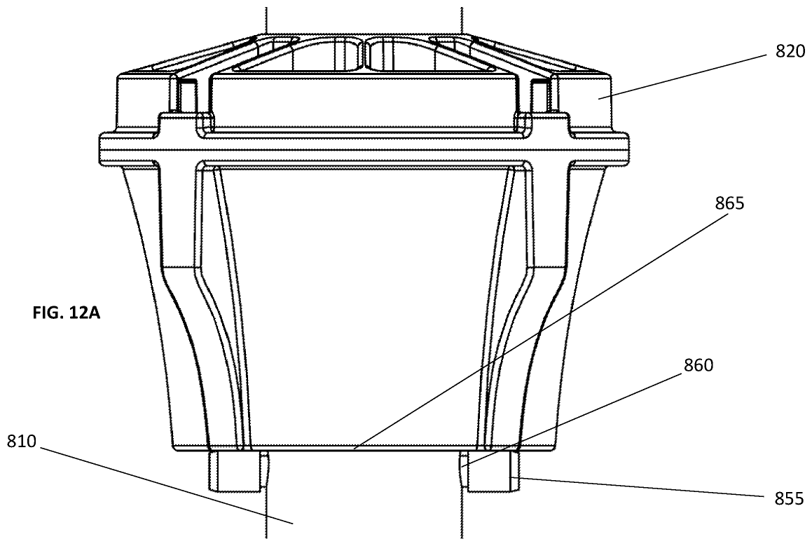

With reference to FIGS. 11A and 11B and according to yet another embodiment of the present disclosure, a hub 720 is shown removably secured to a pole 710, the hub 720 further comprised of a pair of slits (not shown). A retention component is shown comprised of a pin 755 further comprised of two arms 756, 757, the two arms 756, 757 each terminating in respective hooks 758, 759. The pin 755 is further comprised of enlarged outer ends 765, 767, to be inserted within a hole (not shown) of each of the arms 756, 757. The pin 755 is also further comprised of two grooves 770, 772 to receive the arms 756, 757, respectively. The arms 756, 757 are pivotable about the pin 755 when installed thereon. To removably secure the hub 720 to pole 710, the hub 720 is first positioned around the pole 710. The pin 755 is then inserted into the aperture (not shown) of the pole 710. The arms 756, 757 are inserted around the pin 755 and pivotable thereabout, confined within the two grooves 770, 772. The hooks 758, 759 of the arms 756, 757 are then inserted into the slits (not shown) of the hub 720. In another embodiment, the pin 755 could be comprised of a single groove and the arms would be trapped in between the outer ends 765, 767 and the walls of the pole 710.

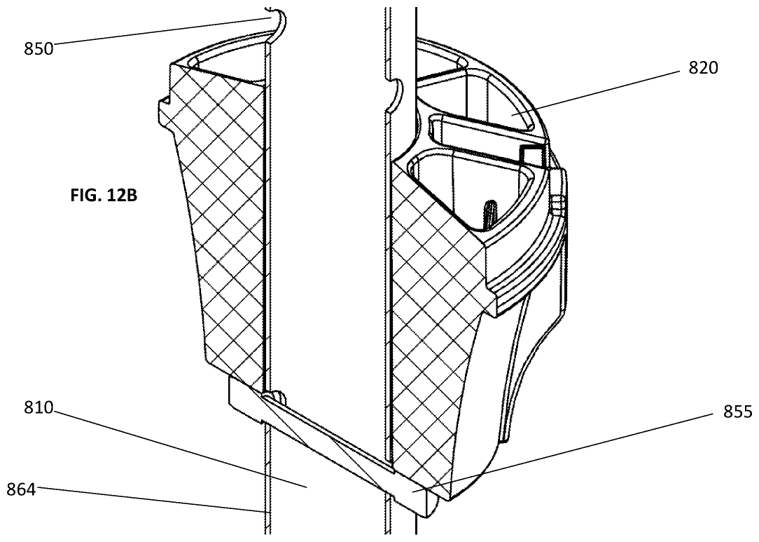

With reference to FIGS. 12A and 12B and according to another embodiment of the present disclosure, a hub 820 is shown removably secured to a pole 810. The pole 810 is comprised of a plurality of slots 850 positioned along the length of the pole 810. A retention component shown as a pin 855 is positioned through the slot 850 and underneath the hub 820, the pin 855 supporting the hub 820 by acting as a retention component thereunder. To remain in place within the slot 850, the pin 855 is further comprised of a single annular groove 860. When the pin 855 is inserted within the slot 850, the annular groove 860 sits on the wall 864 of the pole 810. As such, the pin 855 cannot move laterally with respect to the pole 810 when the annular groove 860 sits on the wall 864 of the pole 810. The annular groove 860 also serves to position the pin 855 in the proper center position on the pole 810. In this particular embodiment, an underside 865 of the hub 820 does not have any recessed portions such that the pin 855 sits directly on the flat underside 865 of the hub 820.

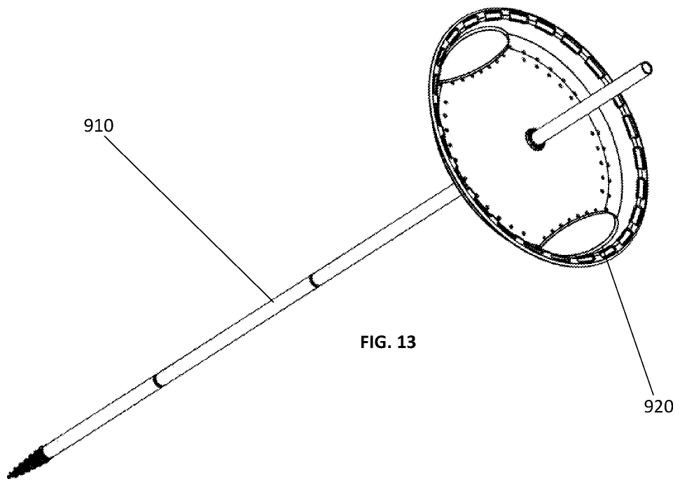

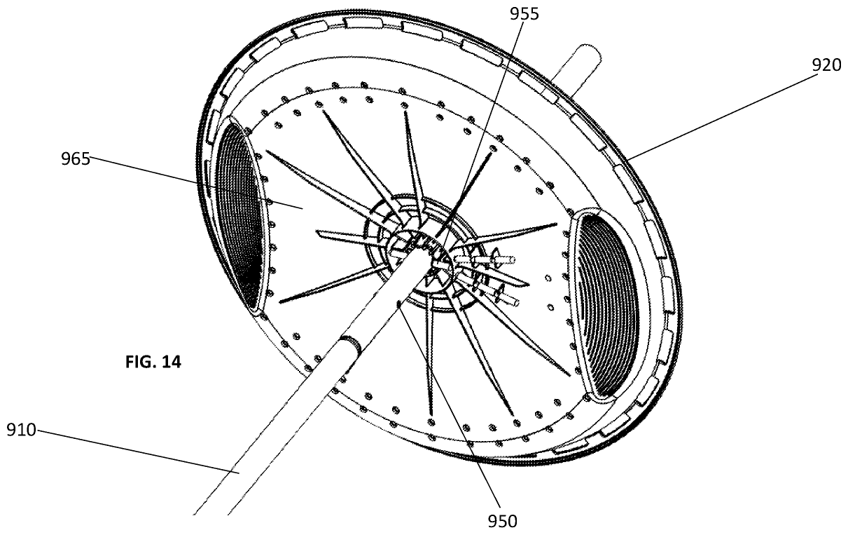

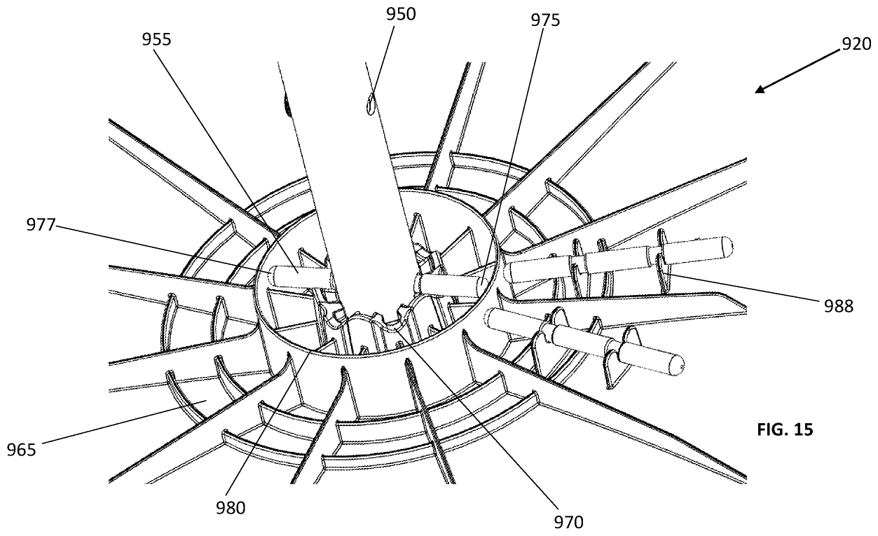

With reference to FIGS. 13, 14 and 15 and according to another embodiment of the present disclosure, a tray 920 is shown releasably secured to a pole 910 by means of a connection system. In a preferred embodiment, the connection system includes a retention component shown as pin 955. The tray 920 is shown configured to receive seeds for birds. As shown, the pole 910 is further comprised of a plurality of apertures 950 in the form of slots along the length of the pole 910. An underside 965 of the tray 920 is further comprised of at least one recessed portion 970, the shape of the recessed portion 970 generally corresponding to the cylindrical shape of the pin 955. A purpose of the recessed portion 970 is to confine and otherwise trap the outer ends 975, 977 of the pin 955 within the recessed portion 970 and inner circumferential wall 980 of the tray 920, so that the pin 955 does not move laterally independently of the tray 920. The underside 965 of tray 920 is further comprised of optional clips 988 to hold additional retention component such as pins 955. A worker skilled in the art would appreciate that although a tray 920 is shown in this particular embodiment, other suitable members could be used, including bird feeders, mailboxes, etc. Suitable members would necessarily have to include use a connection system to lock into or with a retention component.

Many modifications of the embodiments described herein as well as other embodiments may be evident to a person skilled in the art having the benefit of the teachings presented in the foregoing description and associated drawings. It is understood that these modifications and additional embodiments are captured within the scope of the contemplated disclosure which is not to be limited to the specific embodiment disclosed.

It is further understood that references to hubs or trays releasably secured to the pole may also refer to other members, such as modified bird feeders, lights, mailboxes, etc. Meanwhile, reference to pins or dowels may also refer to other equivalent types of retention components.

1. A connection system comprising:
a pole to be secured to a surface, the pole further comprised of at least one aperture;
a member removably secured to the pole, the member further comprised of at least one cavity;
a retention component inserted within the at least one cavity of the member and through the at least one aperture of the pole, the retention component to removably secure the member to the pole.

2. The connection system of claim 1 wherein the retention component is secured within the cavity of the member.

3. The connection system of claim 2 wherein the retention component is one of: a singular L-shaped pin; a threaded rod; an elongated member terminating in a locking member; and, an inner dowel secured within an outer dowel.

4. The connection system of claim 1 wherein the member is a hub, the hub having a plurality of openings to receive corresponding arms.

5. A connection system comprising:
a pole to be secured to a surface, the pole further comprised of at least one aperture;
a member removably secured to the pole, the member further comprised of openings;
a retention component comprising:
a pin inserted through the at least one aperture of the pole; and,
a pair of arms hanging from the pin,
the retention component to removably secure the member to the pole.

6. The connection system of claim 5 wherein the pin is further comprised of at least one groove to receive and secure an end of the pair of arms.

7. The connection system of claim 5 wherein the openings are slits and the arms are further comprised of hooks, the slits to receive the hooks.

8. A connection system comprising:
a pole to be secured to a surface, the pole further comprised of at least one aperture;
a member removably secured to the pole;
at least one retention component inserted through the at least one aperture of the pole, the retention component to removably retain the member on the pole.

9. The connection system of claim 8 wherein the at least one retention component is a pin, the pin further comprised of at least one annular groove, the at least one annular groove to lock into a wall of the pole.

10. The connection system of claim 8 wherein the at least one retention component is further comprised of at least one slit to slide and lock into a wall of the pole.

11. The connection system of claim 8 comprising two retention components, each one of the retention components further comprised of at least one slit to slide and lock into opposed walls of the pole.

12. The connection system of claim 8 wherein the at least one retention component is a pin, the pin having an inner end secured to an outer end, each one of the inner and outer ends terminating in flanges to secure against opposed walls of the pole.

13. The connection system of claim 8 wherein the at least one retention component is a dowel and a bendable raised portion, the bendable raised portion to be fitted inside and releasably lock the dowel to the pole.

14. The connection system of claim 8 wherein the at least one retention component is further comprised of a C-clip and a nipple, the nipple protruding outwardly from the at least one aperture and releasably locking the C-clip into the pole.

15. The connection system of claim 8 wherein the member is further comprised of recessed portions to position the retention component.

16. The connection system of claim 8 wherein the member is one of: a tray and a hub.
